(19) United States
(12) Patent Application Publication
(10) Pub. No.: US 2007/0056322 A1
(43) Pub. Date: Mar. 15, 2007

(54) Refractory body having venting channels and venting vessel for high temperature glass reforming

(76) Inventors: Steven Roy Burdette, Horseheads, NY (US); James Gerard Fagan, Painted Post, NY (US); Sumalee Likitvanichkul, Painted Post, NY (US); Daniel Raymond Sempolinski, Painted Post, NY (US)

Correspondence Address: CORNING INCORPORATED, SP-TI-3-1, CORNING, NY, 14831, US

(21) Appl. No.: 11/357,228

(22) Filed: Feb. 17, 2006

Related U.S. Application Data
(60) Provisional application No. 60/716,480, filed on Sep. 12, 2005.

(51) Int. Cl. C03B 40/02; C03B 37/014; C03B 7/14; C03B 35/00

(52) U.S. Cl. 65/24; 65/374.15; 65/157

(57) ABSTRACT

Disclosed are refractory body and refractory vessel for reforming or reflowing glass materials. The refractory body and vessel have gas venting channels, including surface grooves and/or vias formed on the surface in contact with the glass during high temperature treatment thereof. The refractory body and vessel are particularly advantageous for reflowing fused silica glass at an elevated temperature such as above 1700° C.

### FIELD OF THE INVENTION

The present invention relates to refractory bodies and refractory vessel for forming glass articles at high temperatures. In particular, the present invention relates to surface-textured or perforated refractory bodies and venting vessels comprising such refractory bodies for shaping high purity glass articles at high temperatures. The present invention is useful, for example, in the reforming of high purity fused silica material.

### BACKGROUND OF THE INVENTION

High purity synthetic fused silica material is the material of choice for optical elements in a variety of high precision optical instruments due to its excellent optical and other physical properties. For example, high purity synthetic silica has been used in the production of optical elements of lithographic devices operating in the deep and vacuum UV region for the production of very-large-scale integrated circuits (“VLSI”). Extremely high purity of the silica glass is required for the increasingly higher performance of the lithographic tools. For example, state-of-the-art ArF stepper machines require the fused silica glass used in producing the refractive elements to have metal ion concentration on the scale of ppb by weight.

Various methods have been developed thus far for the production of such high purity fused silica glass. A promising approach is the so-called soot-to-glass process. This and other process entail processing consolidated silica glass at an elevated temperature where the glass is reformed into desired shape. Reforming fused silica glass typically requires a high temperature and/or a long time. To reform fused silica glass in a practical period of time, the temperature should desirably be higher than the softening temperature of the glass, which is about 1650° C. To shorten the processing time, even lower viscosity of the glass is preferred, which means that the glass needs to be heated to an even higher temperature, sometimes up to about 1900° C. High temperature-resistant refractory materials have to be used in constructing the support or vessel on or in which the reforming is conducted.

At high temperatures such as above 1650° C., complex chemical reactions between the silica glass and the refractory materials may take place. Furthermore, silica and the refractories may evaporate or dissociate considerably at such high temperature. Gases are generated in these reactions. For this and other reasons, the present inventors have found that reforming silica glass in vessels or on support made of conventional refractory materials having conventional designs resulted in articles with unacceptable quality. Most notably, the glass articles thus produced tend to be plagued by large cavities near the interface between the glass article and the refractory due to the bubbles formed during reforming. Moreover, the gas generated may permeated into the reformed silica glass article, leading to reduced optical performance.

U.S. Pat. No. 6,505,483 discloses the use of an elastic member with high gas permeability between the refractory and the silica glass to provide gas escape routes. Such elastic member is essentially a high temperature felt liner. As examples of the felt liner, this reference discloses woven or non-woven fabrics of carbon fibers or ceramic fibers.

However, the use of such felt liners in the production of high purity fused silica glass has a plurality of serious drawbacks. These additional materials between the refractory and the silica glass can constitute a significant source of contaminants. At high temperatures where the silica glass article is formed, metal ions tramped in the felt liner are easily mobilized. Because metal ions, especially sodium, at such high temperatures have a very high diffusivity in silica glass, they can quickly contaminate the high purity fused silica glass. Therefore, invariably, these felt liners are required to be purified to a very low contaminants level before use. Because of the high surface area of the felt liner, the fibers tend to react with the purifying agents to a degree that the mechanical integrity of the felt liners is significantly reduced, and in extreme cases, such as for zircon felt liners, they may pulverize. The embrittled felt liner may not function as an effective liner for failing to maintain full coverage of the vessel surfaces or effectively insulate the silica glass from the refractory. Furthermore, the felt liners are inconvenient to use, especially on vertical walls or walls with complex geometric configurations. Clamps, screws, and like, are often required to fix them to the vessel surfaces, adding to the complexity of the vessel design and installation, cost of maintenance and possibility of introducing additional contaminants. In the case of carbon fiber felt liners, its reaction with silica glass at such high forming temperatures (just as graphite does) leads to quick consumption of the liner because of the high surface area, formation of holes in the liner, hence direct contact between the silica glass bulk and the refractory and loss of effectiveness as the insulating liner. In addition, it is desired sometimes to form silica glass articles at high temperatures in the presence of cleansing gases, such as Cl₂. Reactions between the felt liner and such cleansing gas can compromise or accelerate the degradation of the properties of the felt liner materials, rendering them not useable.

Thus, there remains a genuine need of a refractory material design or refractory vessel design without the need of using a felt liner for the reforming of inorganic materials, especially for the formation of high purity fused silica articles. The present invention satisfies this need.

### SUMMARY OF THE INVENTION

According to a first aspect of the present invention, it is provided a refractory body for constructing vessels in which glass articles are formed at a high temperature, characterized in that the refractory body has a plurality of gas venting channels on its surface to be in contact with the glass at the high temperature. In certain embodiments of the refractory bodies of the present invention, the venting channels comprise vias or surface grooves, or both. In a preferred embodiment, the venting channels comprise vias having a diameter between 0.5 to 5 mm, preferably 0.5 to 3 mm, and the via density on the surface is between about 1 to 100 via per square inch (1.55×10³ to 1.55×10⁵ vias per square meter), preferably between about 1 to 50 vias per square inch (1.55×10³ to 7.75×10⁴ vias per square meter). In another preferred embodiment, the venting channels comprise surface grooves having a width between 0.5 to 3 mm, preferably 0.8 to 2 mm, and a depth between about 0.5 to 2 mm, preferably 1-2 mm. In yet another preferred embodiment, the venting channels comprise surface grooves that extend beyond the boundary of the interface between the refractory body and the glass article, such that gas can freely vent. In still another preferred embodiment, the venting channels comprise both surface grooves and vias, and at least some of the vias are located within the grooves. In still another preferred embodiment, the venting channels comprise surface grooves that are essentially parallel to each other. More preferably, the gas venting channels comprise surface grooves that intersect to form a groove network. In a preferred embodiment of the refractory body of the present invention, it is made from a material selected from graphite, BN and SiC, more preferably from graphite. Preferably, for use in connection with high purity fused silica the refractory body has a sodium concentration of below 5 ppm by weight, preferably below 1 ppm, more preferably below about 500 ppb, still more preferably below 100 ppb. The refractory body of the present invention may take various shapes. In a preferred embodiment, the refractory body is a plate.

According to a second aspect of the present invention, it is provided a vessel for forming glass articles at high temperature comprising any of the refractory body described summarily above and in more detail below. In a preferred embodiment of the vessel, it comprises at least one wall which has vias. In another preferred embodiment of the vessel, it comprises at least one wall the inner surface of which has surface grooves. In yet another preferred embodiment, the vessel comprises multiple walls with intercepting inner surfaces, and those intercepting inner surfaces comprise coterminous surface grooves. In still another preferred embodiment of the vessel of the present invention, it is formed by refractory bodies having interlocking edges.

A third aspect of the present invention is directed to a process for thermally reflowing glass at an elevated temperature in any of the refractory vessels described summarily above and in more detail below. In a preferred embodiment of the process of the present invention, the glass is fused silica glass, more preferably high purity fused silica. In another preferred embodiment of the process of the present invention, it comprises a step of heating the glass and the vessel to between 1750-1900° C. during the reflow. Preferably, the refractory vessel used in the process of the present invention is constructed with graphite. More preferably, the graphite for the refractory vessel has a sodium concentration of below about 5 ppm by weight, preferably below 1 ppm, more preferably below about 500 ppb, still more preferably below 100 ppb. In a preferred embodiment of the present invention, the process comprises a step of subjecting the refractory vessel and the glass to an atmosphere comprising a cleansing gas. Preferably, the cleansing gas is Cl₂, especially where the refractory vessel is constructed with graphite.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification.

### BRIEF DESCRIPTION OF THE DRAWINGS

In the accompanying drawings,

FIG. 1 is a schematic illustration of the top plan view of surface groove design of an embodiment of the refractory body of the present invention.

FIG. 2 is a schematic illustration of the top plan view of surface groove design of another embodiment of the refractory body of the present invention.

FIG. 3 is a schematic illustration of the surface channel design of another embodiment of the refractory body of the present invention having both surface grooves and vias.

FIG. 4 is a picture comparing the appearance of two pieces of fused silica glass heated and reflowed in two different graphite crucibles. The sample on the left was heated in a crucible with smooth inner surfaces, and the sample on the right was heated in a crucible with surface grooves schematically illustrated in FIG. 2 according to the present invention.

### DETAILED DESCRIPTION OF THE INVENTION

As used herein, a “refractory body” means a solid mass of refractory material with certain geometric configuration, including but not limited to: plate, which may be flat or curved, dome, ring, and the like. The refractory body may be a single unitary piece of solid material, or a combination of a plurality of single unitary bodies. The refractory body may be made, for example, by machining a block of refractory material to the desired shape and dimension.

As used herein, the term “channel” means a gas passageway.

As used herein, the term “surface groove” means a channel formed on the surface of the refractory body and extending along the surface which, if covered but not blocked by glass, allows gas at the interface of the surface of the refractory body and the glass to vent.

As used herein, the term “via” means a channel formed on the surface of the refractory body and extending throughout the thickness of wall of the refractory body, which, if not blocked, allows gas at the interface of the surface of the refractory body and the glass to vent.

As used herein, a “cleansing gas” is a gas that can react with the refractory body or the glass, or both, to purify them especially of metal contaminants. The cleansing gas may be F₂, Cl₂, Br₂, a halogen-containing compound, and compatible mixtures thereof. The halogen-compound may be HX, CX₄ and SX₆, where X is selected from F, Cl, Br and combinations thereof. Preferably, the cleansing gas is Cl₂.

As used herein, the term “surface region” means the region of the refractory body within 20% of the thickness of the article, or 15 mm depth from the surface thereof, whichever is larger. The concentration of a certain element in the surface region as described in the present application means the average concentration in the surface region of the article.

The production of glass articles, particularly high purity fused silica glass products, sometimes involves the reforming processes run in the temperature range of 1700° C. to about 1900° C. It is known that under high temperature conditions, options of refractory materials for constructing the vessel to contain the glass pieces are limited. Graphite is the preferred refractory material, because it can be cleaned of metal contaminant to the levels required for UV optical applications using chlorine treatments. Graphite, however, tend to react with silica at reforming temperatures to form SiC, SiO and COX at the glass/graphite interface presumably according to, inter alia the following reaction:
C (solid)+SiO₂ (solid)→CO (gas)+SiO (gas).

Moreover, it is known that at around and above 1900° C., SiO₂ solid tends to dissociate and sublime considerably:
SiO₂ (solid)→SiO (gas)+½O₂ (gas).

Both reactions lead to the formation of gas at the glass-graphite interface. It has been found that, if the interface is smooth and non-breathable, and the glass covers the graphite container surface at such high temperature, COx and SiO can be trapped and form bubbles near the interface. At such high temperature, the bubbles may diffuse into the glass, altering the composition of the glass. Even if the bubbles do not migrate into the glass, they can form cavities which have a negative impact on homogeneity of glass properties and hence its utilization. The magnitude of the reaction increases with temperature and is severe at 1900° C. Other refractory materials may undergo gas-generating reactions themselves or with the glass at the high processing temperatures as well. For example, BN is known to produce N₂ at the interface when used as the crucible material for reforming silica glass. As mentioned above, other researchers (U.S. Pat. No. 6,505,484 B1, for example) have used high porosity material such as a refractory felt between the refractory and glass to provide escape routes for the reaction gases. This approach, however, introduces another contamination source and depends on maintaining full coverage of the refractory with the mechanically-weak felt during glass flow. This approach also suffers from other drawbacks discussed above.

The present invention, by providing refractory bodies for constructing high temperature vessels having channels on the surfaces for venting gases, solves this problem.

The present inventors have found that, by providing a grooved surface to the refractory body with which the glass is to be in contact at high temperature, or vias through the walls of the refractory body, gas that would otherwise be trapped between the refractory-glass interface can be channeled away. Unlike the prior art approach of using insulating felt to prevent direct contact between the glass and the refractory wall of the vessel, according to the present invention, glass and refractory walls of the vessel are in direct contact with each other. Thus gas may be generated due to reactions between the refractory and the glass. Nonetheless, because of the channeling function of the grooves and/or vias, the pressure of the gas does not build up. Therefore, the formation of gas bubbles having substantial size can be inhibited.

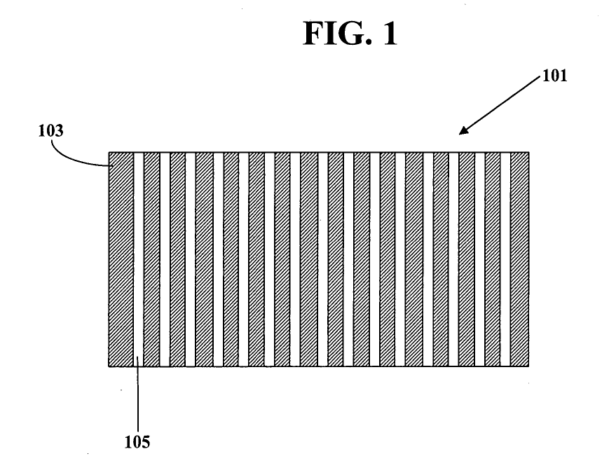

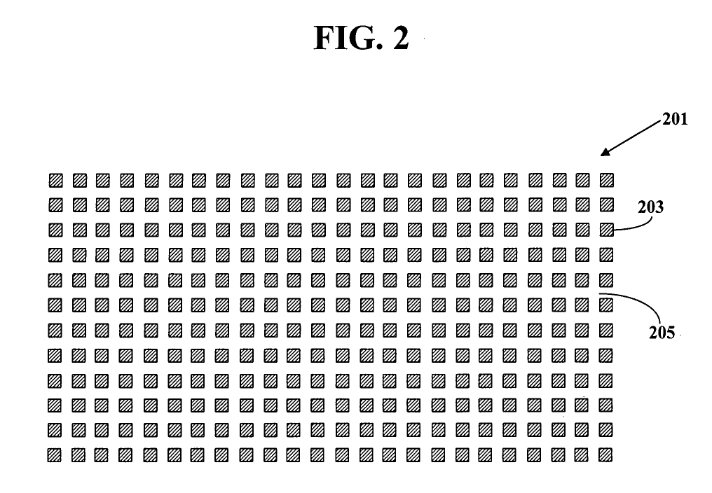

In one embodiment of the refractory body of the present invention, the refractory body has textured surface. FIG. 1 schematically illustrates the surface design of an embodiment of the refractory body of the present invention. On one surface 103 of this refractory body 101, grooves 105 are formed. The grooves 105 are essentially parallel to each other. FIG. 2 schematically illustrates the surface design of another embodiment of the refractory body of the present invention. On one surface 203 of this refractory body 201, a plurality of grooves 205 are formed. The grooves 205 intersect to form a network of gas venting grooves. This cross-hatch groove design is effective in venting gas present at the refractory-glass interface in that gas can vent in multiple directions. In case one direction is blocked by molten glass, gas can still vent through other interconnected grooves in the groove network. The groove design, including pattern and dimensions thereof, depends on the specific glass flow pattern and the distance over which the gas must be evacuated. It has been found that for high temperature forming of glass, textured surface with cross-hatch groove design such as illustrated in FIG. 2 is preferred. The cross-hatch showed in FIG. 2 has a roughly 90° angle. It is also possible, and indeed may be desired especially if the glass has very low viscosity during processing or if the processing time is very long, that the cross-hatch is not 90°. The simple cross-hatch showed in FIG. 2 has only two groups of parallel grooves intersecting each other. Actual refractory blocks may comprise groove network formed by multiple groups of parallel grooves. This is presumably because at higher temperatures, glass tends to have lower viscosity, thus a higher tendency to prematurely fill in the grooves, and a higher probability to block the gas channel. The channel design of FIG. 1, due to its simplicity and ease of manufacture, may be advantageously used at relatively low temperature, where blockage of the channels is less likely to occur.

It is highly desired that under the glass article forming conditions, the glass does not flow to block the ends of the channels on the surface such that gas is entrapped between the glass-refractory interface. The channel width and depth, in addition to the surface texture mentioned above, are factors that need to be taken into consideration in designing the refractory bodies and refractory vessel of the present invention. Generally, channel width is between about 0.5 to 3 mm, preferably between 0.5 to 2 mm. and channel depth is between 0.5 and 2 mm, preferably 1-2 mm. This is especially true for processing fused silica glass at a temperature higher than about 1700° C. Typically, for processing fused silica glass, if the process involves heating the glass to a temperature between 1700-1900° C., it is highly desired that the channel width is less than about 1 mm, yet the depths of the channels are in the range of 0.5-2.0 mm.

In yet another embodiment of the refractory body of the present invention, the body comprises a plurality of vias through the thickness of the walls of the refractory body. Much similar to the function of the surface grooves described above, these vias can effectively channel away the gas present between the glass-refractory interface so that pressure does not build to an extent where bubbles form. The size of the vias and density in terms of number of vias per unit area of the surface of the refractory body are important factors to achieve the desired gas venting function. Typically, if the vias are too large in diameter, glass tends to flow in easily, causing blockage of the channel, of the formation of pins inside the vias. If long/large pins form, they may cause difficulties in releasing the glass article from the refractory body without destroying or breaking the glass article and/or the refractory body. However, it is preferred that the refractory body is reusable. If the vias have too small a diameter, they tend to be blocked by flowing glass easily as well. Generally, the more densely populated the vias on the surface, the more effective the vias are in venting the gas. Therefore, generally, and particularly for processing fused silica glass at high temperature between 1700-1900° C., it is desired that the vias have a diameter between 0.5-5 mm, preferably 0.5-3 mm; and a density between about 1 and 100 vias per square inch (1.55×10³ to 1.55×10⁵ vias per square meter), preferably between about 1 to 50 vias per square inch (1.55×10³ to 7.75×10⁴ vias per square meter). Typically, the higher the processing temperature and/or the longer the processing time, the higher the desired via density. This is presumably because both higher temperatures and longer processing time lead to higher probability of blockage of the channels by flowing glass. It has also been found that vias are quite effective in venting the gas. Thus, in the case of reflowing glass at a high temperature, such as reflowing fused silica glass at above 1800° C., it is desired that vias are formed on the walls of the refractory block to be in contact with the glass.

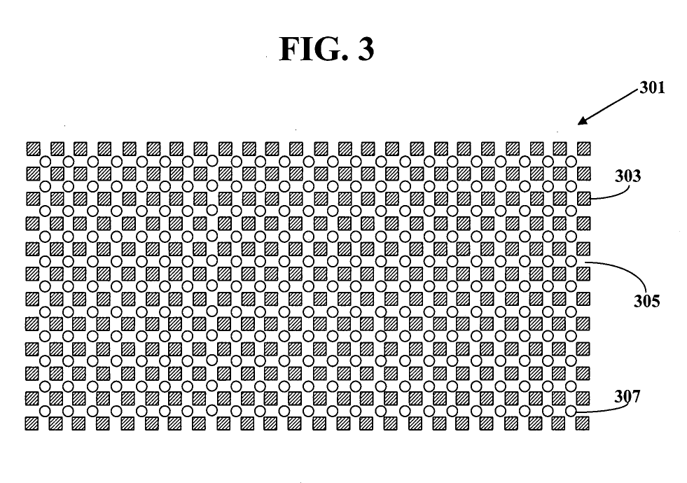

In another embodiment of the refractory body of the present invention, the body comprises both surface grooves and vias on the surface of the body. The combination of both are advantageously used where substantial amount of gas generation is expected, or high probability of blockage of venting channel is anticipated (such as high temperature, low glass viscosity, longer processing time, and the like), or both. Where both surface grooves and vias are formed, desirably the vias are formed within the grooves (thus have diameter less than the width of the grooves). In this design, the vias are less likely to be blocked by flowing glass than if they are located on the ridges defining the channels. FIG. 3 schematically illustrates a channel design of this embodiment. In this embodiment, on the surface 303 of the refractory body 301, a plurality of surface grooves 305 are formed. In addition, a plurality of vias 307 are drilled in the channels 305.

The formation of the surface grooves and vias in the refractory bodies of the present invention can be done by conventional methods and equipment.

The refractory material for the refractory body of the present invention may be any refractory suitable for the glass to be processed under the processing conditions. For forming high purity fused silica glass articles at temperatures between 1700-1900° C., such refractory materials may be graphite, SiC, BN, and the like. Both graphite and BN are non-wetting to silica under those conditions and are machinable materials available at decent purity. Nonetheless, graphite is the most preferred refractory material due to its refractory properties, availability in very high purity and capability of being purified to have a very low level of metal contaminants. It is preferred that the graphite material used is permeable to the cleansing gas, such as Cl₂, so that it can be thoroughly purified before use, and may be further purified during glass reflowing process. Preferably, after the refractory bodies are machined to the desired configuration, but before they are assembled into the refractory vessel of the present invention, they are subject to thorough cleaning and purification. Such cleaning and purification include, but are not limited to, acid cleaning, thermal bake-out and high temperature treatment by halogens or halogen-containing compounds. Preferably, the refractory bodies have a low sodium concentration of lower than about 5 ppm by weight, preferably lower than 1 ppm, more preferably lower than 500 ppb, still more preferably less than 100 ppb by weight, before being assembled into the refractory vessel.

The refractory bodies of the present invention may take various shapes. For example, the refractory body may be a flat or curved plate, a dome, a ring, and the like. Preferably, the body is produced by machining a single piece of refractory monolith. Preferably, the refractory bodies of the present invention are plates.

A second aspect of the present invention is a refractory vessel for forming glass articles therein at high temperature comprising the refractory body of the present invention as described above. The inner surfaces of the walls of the refractory vessel of the present invention to be in contact with the glass when the glass is processed at high temperatures comprise the gas-venting channels, such as surface grooves and/or vias. Thus, the upper surface of the bottom of the refractory vessel comprises surface grooves and/or vias for venting gas.

The refractory vessel of the present invention may be a single refractory block produced by machining a single piece of refractory monolith. In most cases, the refractory vessels of the present invention are assembled from separate/separable individual pieces of refractory bodies by, e.g., screws, fusing, welding, and other fixing means. Preferably, the individual pieces of the refractory bodies have interlocking edge design such that a vessel can be formed without the use of other materials. Such refractory vessel made from a single material is highly desirable for processing high purity glass material, such as high purity fused silica glass, because of the relative ease of purification of the vessel before and during the processing.

It is desired that at least one of the surfaces of the refractory vessel of the present invention comprises vias as described above. If two intersecting walls of the refractory vessel comprise surface grooves, it is highly desirable that at least some of the grooves are co-terminus, so that the channels on those intersecting walls connect to form continuous gas-venting channels.

A third aspect of the present invention is a process for reflowing glass material at an elevated temperature in a refractory vessel of the present invention as described above. The process of the present invention can be advantageously used in reflowing high purity fused silica glass at high temperatures. The process of the present invention is particularly useful if the silica glass is heated to a temperature between about 1700-1900° C. during the reflow. Where high purity fused silica glass is reflowed in the process of the present invention, it is highly desired that the refractory vessel is constructed with graphite. Preferably, if the high purity fused silica glass is for use in the production of optical members in deep UV or vacuum UV lithography, the graphite bodies constituting the vessel have a low sodium concentration of lower than about 5 ppm by weight, preferably lower than about 1 ppm, more preferably lower than about 500 ppb, still more preferably lower than 100 ppb.

In a preferred embodiment of the process of the present invention, high purity glass, such as high purity fused silica glass, is reflowed in the presence of an atmosphere comprising a cleansing gas described above. The cleansing gas is preferably Cl₂.

The present invention has the advantage of simplicity: it solves the bubble formation problem by an easy-to-form surface design of the refractory bodies without the need of refractory liners. The presence of the surface grooves and/vias can also facilitate the separation of the reflowed glass from the crucible after reflowing and/or other treatment at elevated temperatures.

The following non-limiting examples further illustrate the present invention as claimed.

### EXAMPLES

In the following examples, high purity fused silica glass was reflowed at a temperature around 1850° C. in a graphite crucible.

### Example 1

### Comparative Example

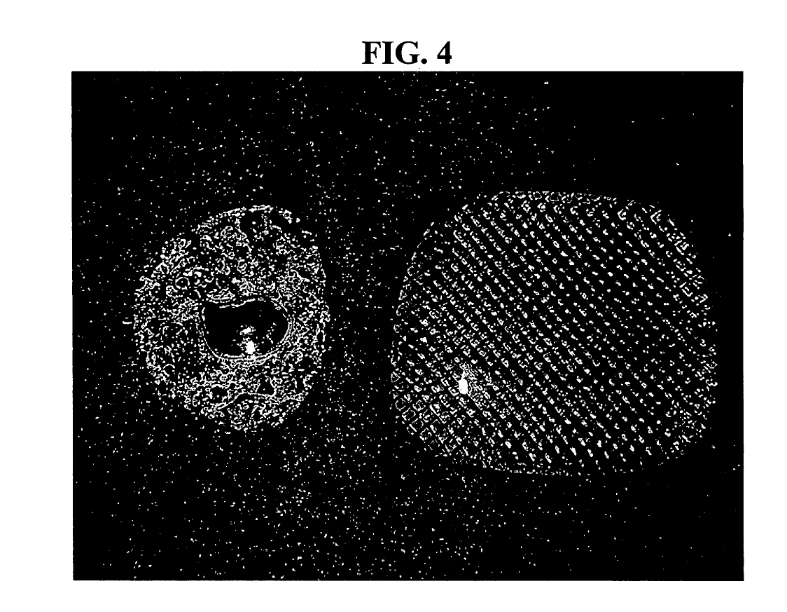

In this example, the crucible was constructed with graphite plates with a smooth surface without surface grooves or vias. A picture was taken of the reflowed glass after it cooled down to room temperature and is shown on the left of FIG. 4. As this picture clearly indicates, a plurality of large bubbles formed at the glass-graphite interface apparently due to gas entrapped. The glass is seriously deformed. It has been found that such deformation of high purity fused silica can lead to compositional and property inhomogeneity unacceptable for many intended applications.

### Example 2

### The Present Invention

In this example, the crucible was constructed with graphite plates with surface grooves having the pattern as schematically illustrated in FIG. 2. A picture of the reflowed glass after it cooled down to room temperature was taken and is shown on the right of FIG. 6. No bubble was clearly visible at the glass-graphite interface. This shows that the gas generated during the reflowing process was channeled away. Though the surface of the reflowed glass in contact with the grooved refractory surface was textured (having cross-hatch pattern corresponding to that of the graphite surface), such textured layer is not thick and can be removed without significant sacrifice to the reflowed glass.

### Example 3

### The Present Invention

In this example, the crucible was constructed with graphite plates with vias formed through the walls. No bubble was clearly visible at the glass-graphite interface. This shows that the gas generated during the reflowing process was channeled away. Moreover, the surface of the reflowed glass in contact with graphite was essentially smooth and free of blisters.

It will be apparent to those skilled in the art that various modifications and alterations can be made to the present invention without departing from the scope and spirit of the invention. Thus, it is intended that the present invention cover the modifications and variations of this invention provided they come within the scope of the appended claims and their equivalents.

What is claimed is:

1. A refractory body for constructing vessels in which glass articles are formed at a high temperature, characterized in that the refractory body has a plurality of gas venting channels on its surface to be in contact with the glass at the high temperature.

2. A refractory body in accordance with claim 1, wherein the venting channels comprise vias or surface grooves, or both.

3. A refractory body in accordance with claim 1, wherein the venting channels comprise vias having a diameter between 0.5 and 5 mm, and the via density on the contact area of surface is about 1 to 100 vias per square inch (1.55×10³ to 1.55×10⁵ vias per square meter).

4. A refractory body in accordance with claim 1 wherein the venting channels comprise surface grooves having a width between 0.5 to 3 mm, and a depth of between 0.5 to 2 mm.

5. A refractory body in accordance with claim 2, wherein the venting channels comprise surface grooves that extend beyond the boundary of the interface between the refractory body and the glass article, such that gas can freely vent.

6. A refractory body in accordance with claim 1, wherein the venting channels comprise both surface grooves and vias, and at least part of the visa are located within the grooves.

7. A refractory body in accordance with claim 1, wherein the venting channels comprise surface grooves that are essentially parallel to each other.

8. A refractory body in accordance with claim 1, wherein the gas venting channels comprise surface grooves that intersect to form a groove network.

9. A refractory body in accordance with claim 1 which is made from a material selected from graphite, BN and SiC.

10. A refractory body in accordance with claim 9 which has a sodium concentration of below 5 ppm by weight.

11. A refractory body in accordance with claim 1 which is a plate.

12. A refractory body in accordance with claim 11, wherein the plate comprises surface grooves on one of its major surfaces.

13. A vessel for forming glass articles at high temperature therein comprising the refractory body of claim 1.

14. A vessel in accordance with claim 13, wherein the vessel comprises at least one wall which has vias.

15. A vessel in accordance with claim 13, wherein the vessel comprises at least one wall the inner surface of which has surface grooves.

16. A vessel in accordance with claim 13, wherein the vessel comprises multiple walls with intercepting inner surfaces, and those intercepting inner surfaces comprise coterminous surface grooves.

17. A vessel in accordance with claim 13, wherein the vessel is formed by refractory bodies having interlocking edges.

18. A vessel in accordance with claim 13, wherein the refractory body is selected from graphite, BN and SiC.

19. A vessel in accordance with claim 18, wherein the refractory body has sodium concentration of below 5 ppm by weight.

20. A process for thermally reflowing glass at an elevated temperature in a refractory vessel of claim 8.

21. A process in accordance with claim 20, wherein the glass is high purity fused silica.

22. A process in accordance with claim 21, comprising heating the glass and the vessel to between 1750-1900° C. during the reflow.

23. A process in accordance with claim 22, wherein the refractory vessel is constructed with graphite.

24. A process in accordance with claim 21, wherein the graphite has a sodium concentration of below 5 ppm by weight.

25. A process in accordance with claim 20, comprising a step of subjecting the vessel and the glass to an atmosphere comprising a cleansing gas.

26. A process in accordance with claim 25, wherein the cleansing gas is Cl₂.
